(19) United States
(12) Patent Application Publication
(10) Pub. No.: US 2025/0016121 A1
(43) Pub. Date: Jan. 9, 2025

(54) INFORMATION PROCESSING METHOD, APPARATUS, DEVICE AND STORAGE MEDIUM

(71) Applicant: Beijing Zitiao Network Technology Co., Ltd., Beijing (CN)

(72) Inventors: Yizhe Yang, Beijing (CN); Jiahe Ma, Beijing (CN); Chong Niu, Beijing (CN); Ang Zhang, Beijing (CN); Zhenghua Hao, Beijing (CN); Huiming Wang, Beijing (CN)

(21) Appl. No.: 18/888,072

(22) Filed: Sep. 17, 2024

(30) Foreign Application Priority Data
Sep. 18, 2023 (CN) 202311204699.9

(51) Int. Cl. H04L 51/02; H04L 51/04

(52) U.S. Cl. CPC H04L 51/02; H04L 51/04

(57) ABSTRACT

The embodiment of the disclosure provides a method, an apparatus, a device and a storage medium for processing information. The method includes: receiving a first interaction message in a first sub-session between a user and a digital assistant, the first interaction message being from the user; determining a first set of information associated with a primary session between the user and the digital assistant based on a primary session identifier of the primary session; determining a sub-session identifier of the first sub-session based on the first set of information; determining, based on the sub-session identifier, a first topic identifier of a first topic to which the first interaction message belongs; obtaining stored context information of the first topic based on the first topic identifier; and obtaining a first reply message of the digital assistant to the first interaction message based on the context information.

### CROSS-REFERENCE

The present application claims priority to Chinese Patent Application No. 202311204699.9, filed on Sep. 18, 2023, and entitled “INFORMATION PROCESSING METHOD, APPARATUS, DEVICE AND STORAGE MEDIUM”, the entirety of which is incorporated herein by reference.

### FIELD

The example embodiments of the present disclosure generally relate to the field of computers, and in particular, to an information processing method, apparatus, device, and computer-readable storage medium.

### BACKGROUND

With the development of information technologies, various terminal devices may provide various services to people in work and life. For example, an application providing a service may be deployed in the terminal device. A terminal device or an application thereof may provide functions such as assistant to a user, to assist a user in completing a task by using a terminal device or an application. How to make such assistant functions more efficient and accurate in serving users is currently a technical issue being explored.

### SUMMARY

In a first aspect of the present disclosure, a method for processing information is provided. The method comprises: receiving a first interaction message in a first sub-session between a user and a digital assistant, the first interaction message being from the user; determining a first set of information associated with a primary session between the user and the digital assistant based on a primary session identifier of the primary session; determining a sub-session identifier of the first sub-session based on the first set of information; determining, based on the sub-session identifier, a first topic identifier of a first topic to which the first interaction message belongs; obtaining stored context information of the first topic based on the first topic identifier; and obtaining a first reply message of the digital assistant to the first interaction message based on the context information.

In a second aspect of the present disclosure, a method for processing information is provide. The method comprises: receiving an interaction message in a session between a user and a digital assistant, the interaction message being from the user and referencing a history message in the session; obtaining a stored set of information of a message dimension associated with the history message based on a message identifier of the history message; determining a topic identifier indicated in the set of information of the message dimension as a target topic identifier of a topic to which the interaction message belongs; obtaining stored context information of the topic based on the target topic identifier; and obtaining a reply message of the digital assistant to the interaction message based on the context information.

In a third aspect of the present disclosure, an apparatus for processing information is provide. The apparatus comprises: a message receiving module, configured to receive a first interaction message in a first sub-session between a user and a digital assistant, the first interaction message being from the user; a first set of information determining module, configured to determine a first set of information associated with a primary session between the user and the digital assistant based on a primary session identifier of the primary session; a sub-session identifier determining module, configured to determine a sub-session identifier of the first sub-session based on the first set of information; a topic identifier determining module, configured to determine, based on the sub-session identifier, a first topic identifier of a first topic to which the first interaction message belongs; a context information obtaining module, configured to obtain stored context information of the first topic based on the first topic identifier; and a reply message obtaining module, configured to obtain a first reply message of the digital assistant to the first interaction message based on the context information.

In a fourth aspect of the present disclosure, an apparatus for processing information is provide. The apparatus comprises: a message receiving module, configured to receive an interaction message of a user and a digital assistant in a session, the interaction message being from the user and referencing a history message in the session; a set of information obtaining module, configured to obtain a stored set of information of a message dimension associated with the history message based on a message identifier of the history message; a topic identifier determining module, configured to determine a topic identifier indicated in the set of information of the message dimension as a target topic identifier of a topic to which the interaction message belongs; a context information obtaining module, configured to obtain stored context information of the topic based on the target topic identifier; and a reply message obtaining module, configured to obtain a reply message of the digital assistant to the interaction message based on the context information.

In a fifth aspect of the present disclosure, an electronic device is provided. The device comprises: at least one processing unit; and at least one memory coupled to the at least one processing unit and storing instructions for execution by the at least one processing unit. The instructions, when executed by the at least one processing unit, causing the electronic device to perform the method of the first aspect or the method of the second aspect.

In a sixth aspect of the present disclosure, a computer-readable storage medium is provided. The computer-readable storage medium has a computer program stored thereon, the computer program is executable by a processor to implement the method of the first aspect or the method of the second aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A-2E illustrate schematic diagrams of example interfaces of a primary session window and sub-session window according to some embodiments;

FIG. 3 illustrates a schematic diagram of a set of information with multiple dimensions in a conversation between a user and a digital assistant according to some embodiments;

FIG. 4 illustrates an example process of communicating an interaction message between a user and a digital assistant according to some embodiments;

FIG. 5 illustrates a schematic diagram of a process of switching topic according to some embodiments;

FIG. 6 illustrates a schematic diagram of a process of accessing a sub-session according to some embodiments;

FIG. 7 is a schematic flowchart of a process of information processing according to some embodiments;

FIG. 8 is another schematic flowchart of a process of information processing according to some embodiments;

FIG. 9 illustrates a block diagram of an apparatus for processing information according to some embodiments;

FIG. 10 shows a block diagram of another apparatus for processing information according to some embodiments; and

FIG. 11 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “comprise” and its variants are to be read as open terms that mean “comprise, but is not limited to”. The term “based on” is to be read as “based at least in part on”. The term “one embodiment” or “this embodiment” is to be read as “at least one embodiment”. The term “some embodiments” is to be read as “at least some embodiments”. Other definitions, explicit and implicit, might be included below.

Herein, unless explicitly stated, “in response to A” performing one step does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained, wherein the relevant users may include any type of rights body, such as individuals, businesses, and groups.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information, such as an electronic device, application program or storage medium.

As an optional but non-limiting implementation, in response to receiving the active request of the user, the manner of sending the prompt information to the user may be, for example, a pop-up window, and the prompt information may be presented in text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

FIG. 1 illustrates a schematic diagram of an example environment 100 in which embodiments of the present disclosure may be implemented. In this example environment 100, an office suite 120 is installed in the terminal device 110. The user 140 may interact with the office suite 120 via the terminal device 110 and/or an attachment device of the terminal device 110. The office suite 120 is able to provide integration of multiple applications or components to the user 140. These applications may serve as application modules in the office suite 120. The applications integrated in the office suite 120 are sometimes referred to as “office applications”, “office components”, “collaborative office platforms”, and the like. As an example, applications integrated in the office suite 120 may comprise, but are not limited to, one or more of: a chat application (also referred to as an instant messaging (IM) application), a document application, an audio and video conferencing application, a mail application, a calendar application, a schedule application, a task application, an objectives and key result (OKR) application.

In some embodiments, the office suite 120 may be downloaded as an application, installed on the terminal device 110. In some embodiments, the office suite 120 may also be accessed in other manners, such as via web page access.

In the environment 100 of FIG. 1, if the office suite 120 is enabled, the terminal device 110 may present an interface 150 of the office suite 120 to the user 140. Interface 150 is also sometimes referred to as a client interface. The interface 150 may include various interfaces that can be provided by the office suite 120, such as a session interface presenting chat content, a video conference interface, a file sharing interface, and the like.

In some embodiments, terminal device 110 communicates with server 130 to enable provision of services to office suite 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, and the like). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure. For example, embodiments of the present disclosure may be applied to any suitable one or more applications, not limited to office suites.

As briefly mentioned above, a digital assistant may be provided to the user to assist the user in completing the target task using the terminal device or application. In an embodiment of the present disclosure, a digital assistant is configured for the user 140. The digital assistant may be implemented in any suitable form. In some embodiments, the digital assistant of user 140 may interact with a user 140 as his/her contact. Such a digital assistant may also uniquely correspond to user 140. In other words, the digital assistant of the user 140 may be specific or exclusive to the user 140. If the user 140 is an individual or person, such a digital assistant may be considered as personal digital assistant. It may be understood that the digital assistant in the embodiments of the present disclosure is based on the authorization of the user 140 to access the data to be granted.

It should be understood that the “uniquely correspond to” or the like in this disclosure is not intended to limit that the digital assistant will be updated accordingly based on the interaction process between the user 140 and the digital assistant.

In the embodiment of the present disclosure, after waking up the digital assistant through the predetermined application, the user 140 interacts with the digital assistant through the primary session. The interaction window corresponding to the primary session may be referred to as a primary session window. As an example, the predetermined application may be an IM application in an office suite. In other examples, the predetermined application may also be another application or component.

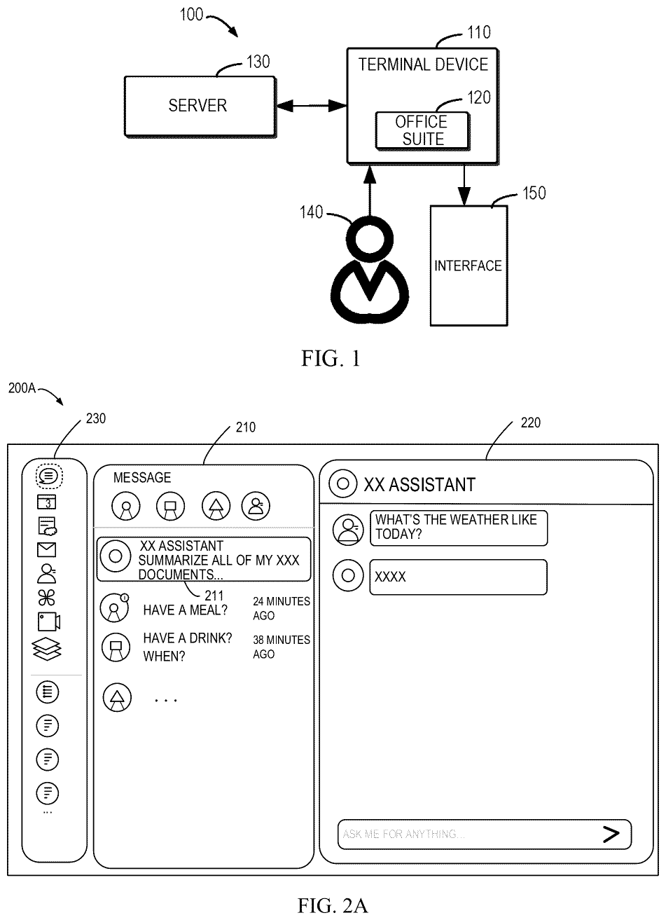

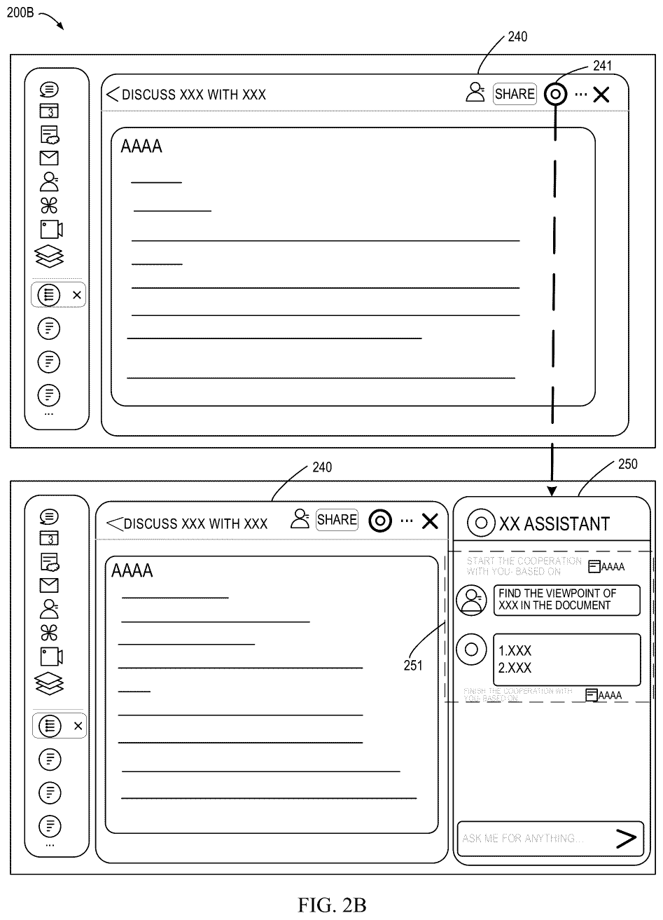

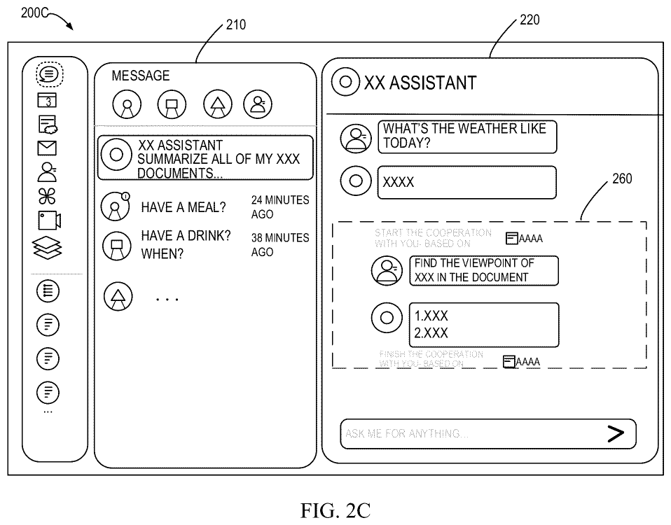

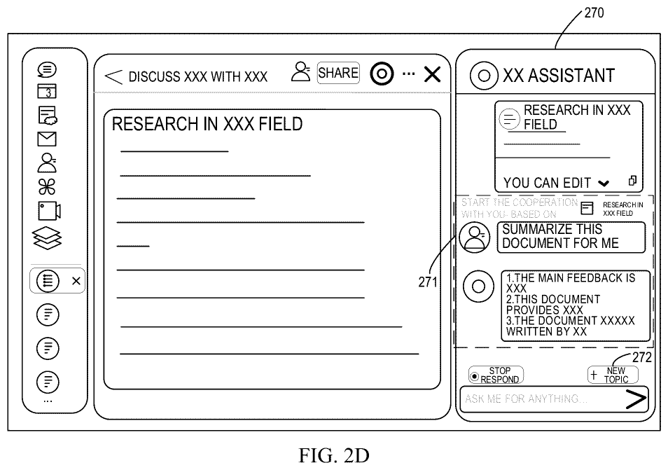

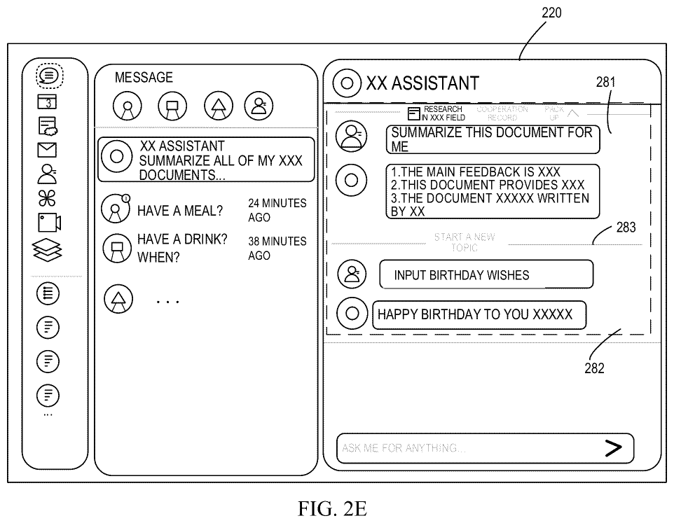

One example of a primary session window in an office suite is described with reference to FIG. 2A. The terminal device presents an interface 200A of the office suite. The interface 200A comprises a navigation bar 230 in which entry controls for a plurality of applications and access entries for a plurality of pages are displayed. By selecting these entry controls and access entries, a corresponding application or page may be activated for browsing or operation. In this example, the chat application is activated. Correspondingly, the interface 200A presents a feed page 210 of the chat application, that is, a session entry list. The session entry item 211 between the user and the digital assistant (“XX assistant” in FIG. 2) is displayed in the feed page 210. The user may click the session entry item 211 of the “XX assistant” such that the primary session window 220 is presented.

In an embodiment of the present disclosure, the session entry with the digital assistant may also be in the contact list. The user may open the primary session window 220 with the digital assistant by triggering the session entry of the digital assistant in the contact list.

In the above examples and the examples below, the digital assistant is shown with the name of “XX assistant”, but it should be understood that this is merely exemplary and not intended to limit the scope of the present disclosure. In embodiments of the present disclosure, the digital assistant may have any suitable name, and the user 140 may customize the name of the digital assistant.

In an embodiment of the present disclosure, other applications than the predetermined application may be used to wake up and then interact with the digital assistant. After the digital assistant is woken up through these non-predetermined applications, the user and the digital assistant may interact with each other through a sub-session. An interaction window corresponding to the sub-session may be referred to as a sub-session window. A user may wake up a digital assistant through a page in a document application, then interact with a digital assistant through a sub-session.

One example of a sub-session window in an office suite is described with reference to FIG. 2B. The terminal device presents an interface 200B of the office suite. In this example, the opened document page 240 is presented in the interface 200B. In this document page 240, an option or control 241 associated with the digital assistant is presented. The user may click on the control 241 to wake up the digital assistant, presenting the sub-session window 250. In this example, the sub-session window 250 is displayed with prompt information “start the cooperation with you-based on AAAA”. Further, the user may interact with the digital assistant through the sub-session window 250. An interaction message (as indicated by dashed box 251) may be presented in the sub-session window 250.

The sub-session between the user and the digital assistant is described above with the document application as an example. It should be understood, however, that user may wake up the digital assistant by any other suitable application.

In some embodiments, the interaction messages in the sub-session window may be displayed in aggregated form in the primary session window. As an example, referring to FIGS. 2B and 2C, an interaction message (as indicated by dashed box 251) in the sub-session window 250 presented in the interface 200B is shown in the primary session window 220 of the interface 200C in an aggregated form of message records (as indicated by dashed box 260). The aggregated form here may refer to that the message records in the sub-session window 250 are presented in a centralized manner, for example, centrally presented in the position indicated in the dotted box 260, with no other messages inserted therein. Therefore, the interaction message between the user and the digital assistant may be recorded in a unified manner, so that the interaction message may be traced back. It is advantageous to provide a user with an efficient assistance experience.

In an embodiment of the present disclosure, the user and the digital assistant may interact with different topics through the primary session and the sub-session. For example, referring to FIG. 2D, a control 272 for starting a new topic is displayed in the sub-session window 270. If the user 140 clicks on the control 272, the topic involved in the interaction in the dotted box 271 may be ended and a new topic started. Accordingly, the message records of the sub-session window 270 presented in the primary session window may comprise interaction messages of different topics, and messages under different topics may be distinguished. As an example, referring to FIG. 2E, message records for one topic in the sub-session window 270 are presented in the region 281 of the primary session window 220, and message records for another topic are presented in the region 282. The new topic is isolated from the previous topic by an identification 283 that “start a new topic”.

In this way, user 140 may be enabled to initiate a conversation with the digital assistant (i.e., a sub-session) in a variety of business scenarios of the office suite 120, and synchronize the interaction messages in the conversation to the conversation (i.e., the primary session) between the user 140 and the digital assistant. Thus, the session context information in different sub-session scenarios may remain relatively independent, and may be synchronized to the primary session, thereby providing a consist and complete interaction experience for the user 140.

For the same topic, a multi-round conversation may need to be performed between the user and the digital assistant. In some scenarios, more natural communication and conversation may be performed between the user and the digital assistant by using deep learning and natural language processing technologies and the like. In this case, the progress of the topic requires perceiving the context information of multiple rounds of conversations between the user and the digital assistant. In general, office suites may provide a variety of applications, such as chat applications (also known as messaging applications), document applications, table applications, mailbox applications, and the like. The digital assistant may also be invoked to talk to the user during the course in which the service corresponding to each application is provided. Whether for a primary session or a sub-session, in order to store context information, a mechanism with scalability and universality needs to be designed. This mechanism needs to support topic isolation in the primary session and the sub-session, so that the conversation between the user and the digital assistant in different application scenarios has a relatively independent context.

Therefore, the embodiments of the present disclosure provide an information processing solution. In this solution, when a first interaction message from the user in a first sub-session between a user and a digital assistant is received, a topic identifier of the topic to which the interaction message belongs is determined based on the set of information of one or more dimensions (for example, the set of information of the primary session dimension, the set of information of the sub-session dimension, etc.). Based on the topic identifier, the stored context information of the topic may be obtained. A reply message of the digital assistant to the interaction message is obtained based on the obtained context information. According to various embodiments of the present disclosure, a topic identifier is maintained using a set of information of one or more dimensions, and context information is stored according to the topic identifier. In this way, in a case that a user and a digital assistant perform multi-round conversations under the same topic, the digital assistant can perceive the same context. Thus, an accurate response may be made to the user's interaction message by the digital assistant, thereby advantageously providing an efficient assistance experience to the user.

Example embodiments of the present disclosure are described in detail below. As described above with reference to FIGS. 2A-2E, the conversation between the user 140 and the digital assistant may involve one or more of: a primary session, a sub-session, a topic, and a message.

The primary session between the user 140 and the digital assistant may be implemented as a single chat group. In this primary session, the messages exchanged between user 140 and the digital assistant have a specific time sequence, and these messages are presented in chronological order. In order to keep the same context of the conversation between the user 140 and the digital assistant on this single timeline, message confusion that may cause the digital assistant to answer irrelevant questions is avoid. In the disclosed embodiments, a set of information of the primary session dimension may be maintained, which may be indexed by the primary session identifier (ID). The set of information of the primary session dimension can record various appropriate information from the perspective of the primary session. For example, a data structure can be maintained on the primary session dimension.

In addition to the set of information of the primary session dimension, in order to solve the context awareness of a certain message, in some embodiments of the present disclosure, a set of information of message dimension may be maintained, and the message ID may be used as an index. Such messages may be sent by the user 140 or sent by the digital assistant.

In some embodiments, the dimensions of the machine learning model may only perceive the topic when the digital assistant replies to the user's message. To this end, a set of information of topic dimensions may be maintained, which may be indexed with a topic ID. The set of information of topic dimensions may record various suitable information, such as various relevant identifier, from the perspective of the topic. For example, a data structure may be maintained in a topic dimension. Other context basic information, such as a primary session ID, a user ID, a message ID, etc., may be read from the set of information of the topic dimension. In this way, the destination of the reply message of the digital assistant may be determined, that is, knowing which message of which user to reply, where the message is sent.

In the office suite 120, the sub-session between the user 140 and the digital assistant is also an important interaction form. To this end, a set of information of sub-session dimensions may be maintained, which may be indexed with a sub-session ID. The set of information of the sub-session dimension may record various appropriate information, such as various related identifier, from the perspective of the sub-session. For example, a data structure may be maintained in a sub-session dimension.

The sets of information of the primary session dimension, the sub-session dimension, the topic dimension, and the message dimension are summarized above. These sets of information of different dimensions may employ any suitable data structure, and may comprise any suitable fields. Table 1 describes an example of a set of information.

TABLE 1

| Field | Meanings and Remarks |
|---|---|
| SessionID | The topic identifier; in the case of the primary |
| | session dimension and the sub-session dimension, |
| | it may be identifier of the newest topic. |
| ChatID | main session identifier |
| StartMessageID | representation of the first message |
| ThreadID | sub-session identifier |
| UserID | user identifier |
| AssistID | digital assistant identifier |
| CreatorID | only applicable to the message dimension, the |
| | identifier of the sender of the message |
| AssistMessageID | only applicable to the message dimension, and if |
| | the message is sent by the digital assistant, the |
| | message may be identified by the provider of the |
| | machine learning service |
| ChatModeID | the identifier of the window presenting the sub- |
| | session, also referred to as a sub-session window |
| | ID. Note that, a sub-session window ID may be |
| | created if the user wakes up the digital assistant |
| | through the application and presents a sub- |
| | session window. If the user has a further action |
| | in the window, such as sending a message, a |
| | corresponding sub-session ID may be created. |
| TenantID | identifier of a tenant to which an account logged |
| | in by a user belongs |
| IsThreadMode | indication of whether being a sub-session mode |
| AppScene | sub-session is woken up or triggered by which |
| | application. |

It should be understood that the number, name, etc. of the fields shown in Table 1 are exemplary and are not intended to be limiting. In an embodiment of the present disclosure, the set of information may comprise any identification information, indication information, or the like related to the conversation between the user and the digital assistant.

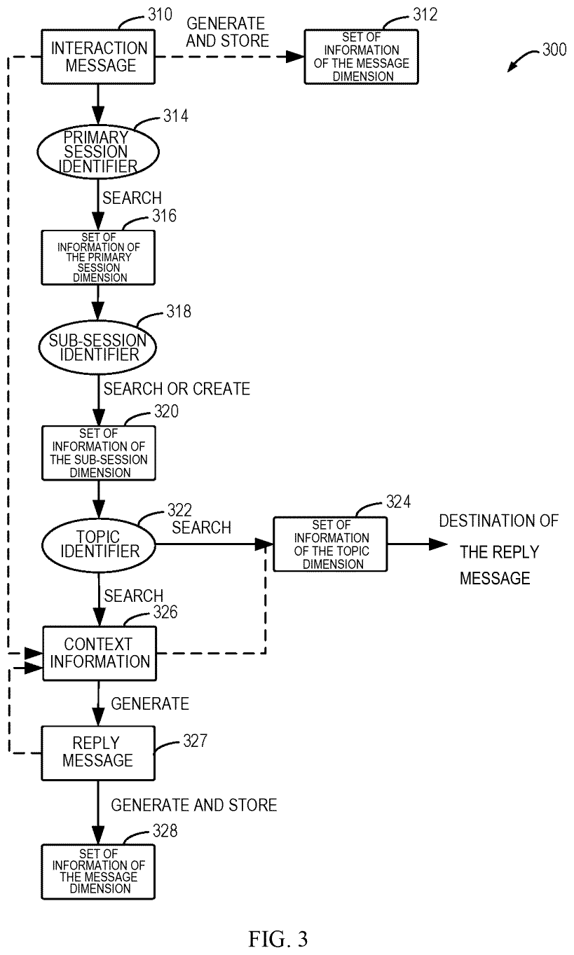

FIG. 3 illustrates a schematic diagram 300 of a set of information with multiple dimensions in a conversation between a user and a digital assistant according to some embodiments. For ease of discussion, the embodiment shown in FIG. 3 is described below in conjunction with FIG. 1 and FIGS. 2A-2E. It should be understood that this is merely illustrative and not limiting.

At the terminal device 110, a multi-round conversation may be performed between the user 140 and the digital assistant under the same topic. In some embodiments, the topic may be conducted in a sub-session triggered by a certain application. Such a sub-session may sometimes be referred to herein as a “first sub-session”.

In this case, the server 130 may receive an interaction message, such as interaction message 310, in a first sub-session between a user 140 and a digital assistant from the terminal device 110. For ease of description, the interaction message 310 may also be referred to as a first interaction message. The interaction message 310 is from the user 140. The server 130 may determine a set of information 316 associated with a primary session between the user 140 and the digital assistant based on a primary session identifier 314 of the primary session, also referred to as a first set of information 316 or a set of information of primary session dimensions. For example, the primary session identifier 314 may be used as an index to search a set of information of primary session dimension. If the set of information corresponding to the primary session identifier 314 is searched, it may be used as the set of information 316 of the primary session dimension. If the set of information associated with the primary session identifier 314 is not searched, this means that this is the process of initialization. Accordingly, a topic identifier may be created and a set of information 316 associated with the primary session identification 314 may be created, where the created topic identifier is stored.

After obtaining the set of information 316 of the primary session dimension, the sub-session identifier 318 of the first sub-session may be determined based on the set of information 316 of the primary session dimension. For example, the sub-session identifier 318 may be determined according to the “ThreadID” field shown in Table 1.

Next, the server 130 may determine, based on the sub-session identifier 318, a topic identifier of a topic (also referred to as a “first topic”) to which the first interaction message belongs, also referred to as a “first topic identifier” 322. In some embodiments, the set of information (also referred to as the “second set of information”) 320 of the sub-session dimension may be searched by the sub-session identifier 318. For example, the set of information 320 of the sub-session dimensions associated with the first sub-session may be searched based on the sub-session identifier 218 of the first sub-session. If the set of information 320 of the sub-session dimension is searched, the identifier of the current topic indicated in the set of information 320 of the sub-session dimension may be determined as the first topic identifier 322. For example, the “SessionID” shown in Table 1 may be determined as the first topic identifier 322.

If the set of information 320 of the sub-session dimension is not searched, the first topic identifier 322 of the first topic and the set of information 320 of the sub-session dimension may be created, and the first topic identifier 322 is included in the set of information 320 of the sub-session dimension for storage. In this case, the stored first topic identifier 322 is used as an identifier of the current topic of the first sub-session.

In the embodiments described above, the topic identifier is determined from a set of information of a sub-session dimension. Alternatively, in some embodiments, the topic identifier 322 may be directly determined from the set of information 316 of the primary session dimension. For example, the set of information 316 of the primary session dimension may store an identifier of a newest topic of a session (including a primary session and a session) between the user and the digital assistant.

The server 130 may obtain the stored context information 326 of the first topic based on the first topic identifier 322. For example, the context information 326 of the first topic may be obtained by search a database or memory storing context information. The server 130 may then obtain a reply message (also referred to as a “first reply message”) 327 for the first interaction message by the digital assistant based on the context information 326. For example, the context information 326 along with the interaction message 310 may be sent to the machine learning model, which generates the reply message 327.

As shown in FIG. 3, in some embodiments, the interaction message 310 and the reply message 327 may be stored as part of the context information 326. As such, the context information about the first topic may be continually updated to facilitate providing context for subsequent rounds of conversation.

In some embodiments, in a case where the first reply message is obtained, the server 130 may determine, based on the first topic identifier 322, a set of information (also referred to as a “third set of information”) 324 of the topic dimension associated with the first topic. Based on the set of information for the topic dimension, a destination of the reply message 327 may be determined. Therefore, it can be determined which message of which user the digital assistant currently replies, and the reply message is to be sent to the terminal device.

As mentioned above, to address context awareness from message respective, a set of information of message dimensions may be maintained. In some embodiments, as shown in FIG. 3, a set of information (also referred to as a “fourth set of information”) 312 of message dimensions may be generated and stored based on the interaction message 310. That is, the set of information may be maintained for a message sent by the user to store related identifiers, indications, and the like. For example, the set of information 312 of message dimension may comprise many kinds of information, including, for example, but not limited to, the message identifier of the interaction message 310, the sub-session identifier 318, and the first topic identifier 322.

Alternatively or additionally, in some embodiments, a set of information (also referred to as a “fifth set of information”) 328 of message dimension associated with reply message 327 may be generated and stored. That is, the set of information may be maintained for messages sent by the digital assistant to store related identifiers, indications, and the like. The set of information includes at least a message identifier of the reply message 327, a sub-session identifier 318, and a first topic identifier 322.

In such embodiments, the set of information of message dimension may maintained for the message sent by the user and/or the message sent by the digital assistant. With this set of information of message dimension, the topic may be re-started after one topic ends. Specifically, in some embodiments, after the second topic different from the first topic is started, the server 130 may receive the second interaction message from the user 140. If the second interaction message references at least one of the first interaction message 310 and the first reply message 327, the server 130 may search the set of information for the message dimension associated with the referenced message(s) based on the message identifier of the message(s). If the first topic identifier 322 is determined from the set of information of the searched message dimension, the server 130 may obtain the stored context information 326 associated with the first topic identifier 322 based on the first topic identifier, and generate a second reply message for the second interaction message based on the obtained context information 326. In this way, the first topic that would otherwise have ended may be re-started.

It should be appreciated that messages in a sub-session may be recorded into the primary session as described above with reference to FIG. 2E. Therefore, the second interaction message described herein for re-starting the first topic may be from a sub-session in which the first topic occurs, or may be from a primary session between the user 140 and the digital assistant. In other words, even if the sub-session is closed, the user 140 may re-start the topic in the sub-session through the message record in the primary session.

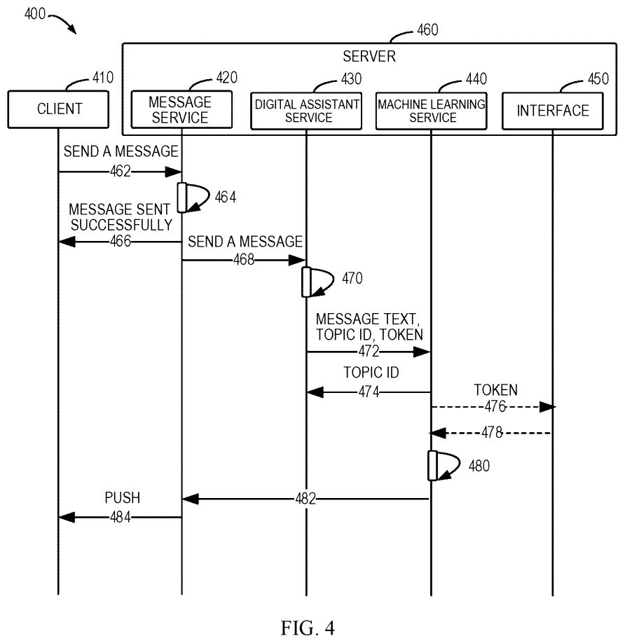

In order to more clearly understand the information processing solution of the present disclosure, an example process 400 for communicating an interaction message of a user and a digital assistant between a client and a server is described with reference to FIG. 4.

In the example of FIG. 4, client 410 may run at terminal device 110 for implementing office suite 120. The service end 460 may run at the server 130. Merely by way of example, the service end 460 may include, but is not limited to, a message service 420, a digital assistant service 430, a machine learning service 440, and an interface 450. The message service 420 may be used, for example, to provide services related to messaging applications in office suite 120. The digital assistant service 430 may be used, for example, to provide services related to digital assistants. The machine learning service 440 may utilize any suitable machine learning model to provide various suitable services in the office suite 120, for example, a machine learning model may be utilized when generating an answer to the user by the digital assistant. The interface 450 may be, for example, an open application program interface.

In particular, FIG. 4 illustrates an example process 400 for a single round conversation between a user 140 and a digital assistant. The user 140 sends a message to the digital assistant through the client 410. As shown in FIG. 4, the client 410 sends (462) a message from the user 140 to the message service 420. The message service 420 determines (464) whether the message was successfully received. If successful, the message service 420 sends (466) a notification to the client 410 that the message was successfully sent. The message service 420 then sends (468) a message received from client 410 to digital assistant service 430 and instructs digital assistant service 430 that user 140 sends a message to the digital assistant.

The digital assistant service 430 may determine (470) a topic identifier of a topic to which the message belongs, and obtain context information of the topic to which the message belongs based on the topic identifier. The determination of the topic identifier is as described above with reference to FIG. 3. For example, before the message is passed to the machine learning service 440, the digital assistant service 430 may read the set of information of the primary session dimension, such as the structure shown in Table 1, with the primary session identifier (e.g., ChatID) as an index. The digital assistant service 440 may obtain a topic ID within the set of information. The digital assistant service 430 may then pass the message to the machine learning service 440 in conjunction with other data or the like. The machine learning service 440 may perceive the same topic ID to determine the respective semantic context. If there is no topic ID of the primary session dimension in the memory or the database, it may be considered that the current state is the initialized state. In this case, an empty topic ID may be delivered to the machine learning service 440, and a new topic ID may be generated and returned by the machine learning service 440. The digital assistant service 430 may then store a set of information of the ongoing primary session dimension, which includes the generated topic ID. In a subsequent conversation, for example, a next round of conversation, the stored topic ID may be obtained. In this way, for the same topic, the machine learning service 440 can perceive the same context information, thereby improving consistency and accuracy.

Continuing with the process of FIG. 4, after obtaining the topic ID, the digital assistant service 430 may send (472) information related to the context information to the machine learning service 440, such as, but not limited to, message text, topic identifier, token, and the like.

The machine learning service 440 may extract the topic ID from the received information and return (474) to the digital assistant service 430, thereby indicating that information about the topic ID has been successfully received. Additionally, in some embodiments, the machine learning service 440 may send (476) a token extracted from the received information to interface 450 for the application, to authenticate whether the message is a legitimate message or whether being authorized to process the message, or the like. Accordingly, the interface 450 may conduct corresponding authentication and send (478) the authentication results to the machine learning service 440.

The machine learning service 440 may obtain (480) a message to be returned to the user 140 by performing some processing on the context information, for example, using a machine learning model or the like. In some embodiments, in the reply process, the message to reply may, for example, be returned (482) to the message service 420 in a streaming form and then pushed (484) by the message service 420 to the client 410.

In the case of a multi-turn conversation, a process similar to process 400 may be performed for each round of conversation.

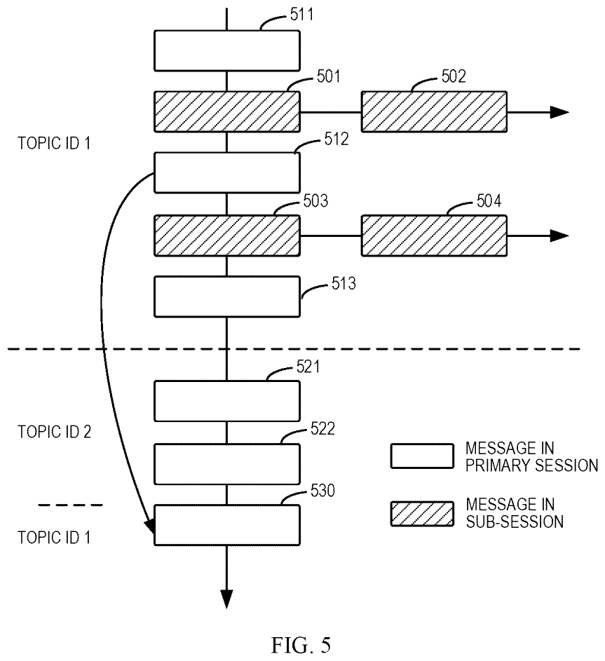

The topics occurring in the sub-session may be restarted as described above with reference to FIG. 3. Similarly, the topic in the primary session may be re-started after being ended. One example is described below with reference to FIG. 5. As shown in FIG. 5, the messages 511, 512, 513 are messages in the primary session and belong to topic 1 with identifier as “topic ID1”, and messages 521 and 522 are messages in the primary session and belong to topic 2 with identifier as “topic ID2”. In some embodiments, the primary session between the user 140 and the digital assistant may be implemented as a single chat group. In this primary session, the messages exchanged between user 140 and the digital assistant have a specific time sequence, and these messages are presented in chronological order, such as shown in FIG. 3.

The messages 501 and 502 are messages belonging to the same topic in the sub-session, and messages 503 and 504 are messages belonging to another topic in the sub-session. The two sub-sessions may be the same session or different sessions. As shown in FIG. 5, messages in the primary session are expanded longitudinally, and messages in the sub-session are expanded in a transverse direction.

After topic 1 ends and topic 2 is started, message 530 from user 140 references message 512 belonging to topic 1, which may be considered as a historical message. Based on the message identifier of message 512, a stored set of information of message dimension associated with message 512 may be obtained. The topic identifier indicated in the set of information may be determined as a topic identifier of a topic to which the message 512 belongs, and is also referred to as a target topic identifier. For example, the SessionID in the structure shown in Table 1 may be determined as the target topic identifier. Then, based on the target topic identifier, the stored context information of the topic may be obtained, and a reply message of the digital assistant to the message 530 is obtained according to the context information. Thus, the topic that would otherwise have ended is re-started and may continue the previous context.

As mentioned above, a plurality of applications in the office suite 120 may access a sub-session, that is, a sub-session with a digital assistant may be triggered through a plurality of applications. Additionally, in some embodiments, in response to the trigger operation on the sub-session by the application, the server 130 may obtain a valid identifier of the window of the sub-session and initialize the sub-session based on the valid identifier of the window. The valid identifier of the window of the first sub-session may be obtained in various manners. For example, it may firstly be determined whether the window identifier provided by the application is valid. If the window identifier is valid, the window identifier may be determined as the valid identifier of the window; instead, if the window identifier is invalid, a new window identifier may be generated as the valid identifier of the window.

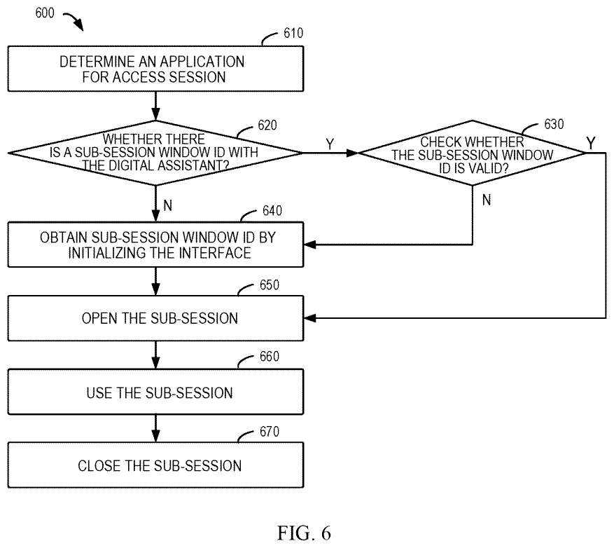

FIG. 6 illustrates a schematic diagram of a process 600 of accessing a sub-session according to some embodiments. As shown in FIG. 6, at block 610, an application for accessing session may be determined. At block 620, it is determined whether there is a sub-session window ID with the digital assistant, such as the ChatModeID in Table 1. If the sub-session window ID is already present, the process 600 proceeds to block 630. At block 630, it may be checked whether the existing sub-session window ID is valid. If so, the process 600 proceeds to block 650. If not, or if no sub-session window ID is determined at block 620, the process 600 proceeds to block 640. At block 640, the sub-session window ID is obtained by initializing the interface. Further, at block 650, the sub-session may be opened, and at block 660, a sub-session may be used, i.e., the user 140 and the digital assistant may interaction in the sub-session. Then, at block 370, the sub-session may be closed. The closing of the sub-session may be in response to the end of the sub-session scenario. For example, the user 140 may close the sub-session window, the user closes the tab page of the application, the document is deleted in the case of the document application, the end of the meeting in the meeting application, and the like. In this case, the close interface may be called to close the session. Alternatively or additionally, the closing of the sub-session may be in response to the sub-session not being updated for a predetermined duration.

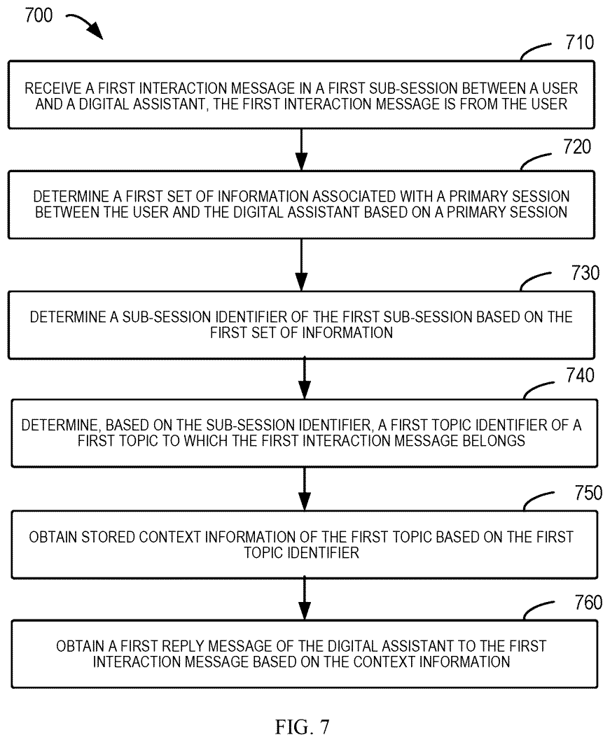

FIG. 7 is a schematic flowchart of a process 700 for processing information according to some embodiments. Process 700 may be implemented at server 130. The process 700 is described below with reference to FIG. 1.

At block 710, the server 130 receives a first interaction message in a first sub-session between a user and a digital assistant, the first interaction message is from the user.

At block 720, the server 130 determines a first set of information associated with a primary session between the user and the digital assistant based on a primary session identifier of the primary session.

At block 730, the server 130 determines a sub-session identifier of the first sub-session based on the first set of information.

At block 740, the server 130 determining, based on the sub-session identifier, a first topic identifier of a first topic to which the first interaction message belongs.

In some embodiments, determining the first topic identifier of the first topic to which the first interaction message belongs comprises: searching, based on the sub-session identifier, a second set of information associated with the first session; and determining, in response to the search of the second set of information, an identifier of a current topic indicated in the second set of information as the first topic identifier.

In some embodiments, the process 700 further comprises: the server 130 generates the first topic identifier and the second set of information in response to the failure of search of the second set of information; and stores the second set of information comprising the first topic identifier, wherein the first topic identifier is stored as an identifier of a current topic of the first sub-session.

At block 750, the server 130 obtains stored context information of the first topic based on the first topic identifier.

At block 760, the server 130 obtains a first reply message of the digital assistant to the first interaction message based on the context information.

In some embodiments, the process 700 further comprises: the server 130 stores the first interaction information and the first reply message as part of the context information.

In some embodiments, the process 700 further comprises: in response to the obtaining of the first reply message, the server 130 determines a third set of information associated with the first topic based on the first topic identifier; and determines a destination of the first reply message based on the third set of information.

In some embodiments, the process 700 further comprises: the server 130 generates a fourth set of information associated with the first interaction message, wherein the fourth set of information comprises at least a message identifier of the first interaction message, the sub-session identifier, and the first topic identifier; and generates a fifth set of information associated with the first reply message, wherein the fifth set of information comprises at least a message identifier of the first reply message, the sub-session identifier, and the first topic identifier.

In some embodiments, the process 700 further comprises: the server 130 receives a second interaction message from the user after a second topic different from the first topic is started; in response to the second interaction message referring to at least one message of the first interaction message or the first reply message, searches a set of information associated with the at least one interaction message based on a message identifier of the at least one message; in response to determining the first topic identifier from the searched set of information, obtains the stored context information associated with the first topic identifier based on the first topic identifier; and generates a second reply message for the second interaction message based on the obtained context information.

In some embodiments, the process 700 further comprises: the server 130 obtains a valid identifier of a window of the first sub-session in response to a trigger operation on the first sub-session via an application; and initializes the first sub-session based on the valid identifier of the window.

In some embodiments, obtaining the valid identifier of the window of the first sub-session comprises: determining whether a window identifier provided by the application is valid; in response to the window identifier being valid, determining the window identifier as the valid identifier of the window; and in response to the window identifier being invalid, generating a new window identifier as the valid identifier of the window.

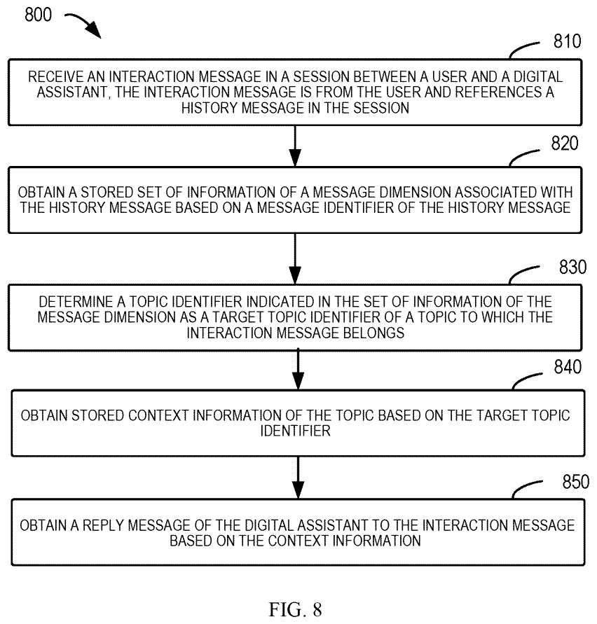

FIG. 8 shows another schematic flowchart of a process 800 of information processing according to some embodiments. The process 800 may be implemented at server 130. The process 800 is described below with reference to FIG. 1.

At block 810, the server 130 receives an interaction message in a session between a user and a digital assistant, the interaction message is from the user and referencing a history message in the session

At block 820, the server 130 obtains a stored set of information of a message dimension associated with the history message based on a message identifier of the history message.

At block 830, the server 130 determines a topic identifier indicated in the set of information of the message dimension as a target topic identifier of a topic to which the interaction message belongs.

At block 840, the server 130 obtains stored context information of the topic based on the target topic identifier.

At block 850, the server 130 obtains a reply message of the digital assistant to the interaction message based on the context information.

In some embodiments, the process 800 further comprises: the server 130 obtains a set of information of a session dimension associated with the session based on a session identifier of the session; and updates an identifier of a current topic in the set of information of the session dimension to the target topic identifier.

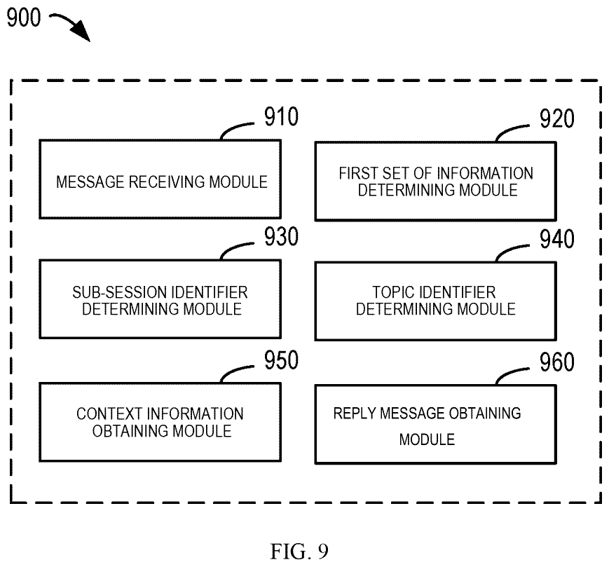

FIG. 9 is a schematic structural block diagram of an apparatus 900 for processing information according to some embodiments. The apparatus 900 may be implemented or included in the server 130. The various modules/components in the apparatus 900 may be implemented by hardware, software, firmware, or any combination thereof.

The apparatus 900 comprises a message receiving module 910, configured to receive a first interaction message in a first sub-session between a user and a digital assistant, the first interaction message being from the user. The apparatus 900 further comprises a first set of information determining module 920, configured to determine a first set of information associated with a primary session between the user and the digital assistant based on a primary session identifier of the primary session. The apparatus 900 further comprises a sub-session identifier determining module 930, configured to determine a sub-session identifier of the first sub-session based on the first set of information. The apparatus 900 further comprises a topic identifier determining module 940, configured to determine, based on the sub-session identifier, a first topic identifier of a first topic to which the first interaction message belongs. The apparatus 900 further comprises a context information obtaining module 950, configured to obtain stored context information of the first topic based on the first topic identifier. The apparatus 900 further comprises a reply message obtaining module 960, configured to obtain a first reply message of the digital assistant to the first interaction message based on the context information.

In some embodiments of this disclosure, the apparatus 900 further comprises: in some embodiments, the topic identifier determining module 940 is further configured to: based on the sub-session identifier, search a second set of information associated with the first session; and determines, in response to the search of the second set of information, an identifier of a current topic indicated in the second set of information as the first topic identifier.

In some embodiments of this disclosure, the topic identifier determining module 940 is further configured to: generates the first topic identifier and the second set of information in response to the failure of search of the second set of information; and stores the second set of information comprising the first topic identifier, wherein the first topic identifier is stored as an identifier of a current topic of the first sub-session.

In some embodiments of this disclosure, the apparatus 900 further comprises a storing module, configured to: store the first interaction information and the first reply message as part of the context information.

In some embodiments of this disclosure, the apparatus 900 further comprises a destination determining module configured to: in response to the obtaining of the first reply message, determine a third set of information associated with the first topic based on the first topic identifier; and determine a destination of the first reply message based on the third set of information.

In some embodiments of this disclosure, the apparatus 900 further comprises a fourth set of information generating module configured to: generate a fourth set of information associated with the first interaction message, the fourth set of information comprises at least a message identifier of the first interaction message, the sub-session identifier, and the first topic identifier; and a fifth set of information generating module configured to: generate a fifth set of information associated with the first reply message, the fifth set of information comprises at least a message identifier of the first reply message, the sub-session identifier, and the first topic identifier.

In some embodiments, the reply message obtaining module 960 is further configured to: receive a second interaction message from the user after a second topic different from the first topic is started; in response to the second interaction message referring to at least one message of the first interaction message or the first reply message, search a set of information associated with the at least one interaction message based on a message identifier of the at least one message; in response to determining the first topic identifier from the searched set of information, obtain the stored context information associated with the first topic identifier based on the first topic identifier; and generate a second reply message for the second interaction message based on the obtained context information.

In some embodiments, the apparatus further comprises an initializing module configured to: obtain a valid identifier of a window of the first sub-session in response to a trigger operation on the first sub-session via an application; and initialize the first sub-session based on the valid identifier of the window.

In some embodiments, the initializing module is further configured to: determine whether a window identifier provided by the application is valid; in response to the window identifier being valid, determine the window identifier as the valid identifier of the window; and in response to the window identifier being invalid, generate a new window identifier as the valid identifier of the window.

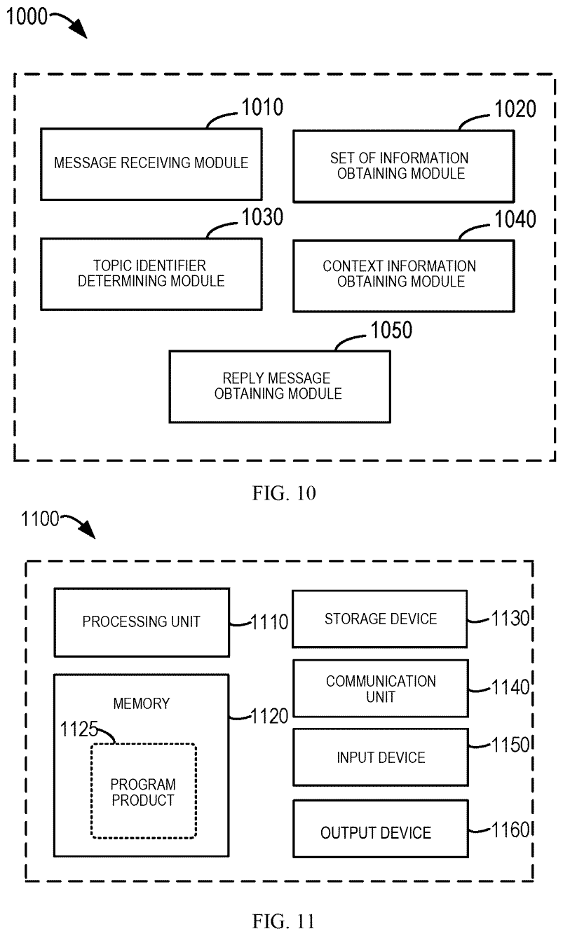

FIG. 10 is a schematic structural block diagram of an apparatus 1000 for processing information according to some embodiments of the present disclosure. The apparatus 1300 may be implemented or included in the server 130. The various modules/components in the apparatus 1000 may be implemented by hardware, software, firmware, or any combination thereof.

The apparatus 1000 comprises a message receiving module 1010, configured to receive an interaction message of a user and a digital assistant in a session, the interaction message being from the user and referencing a history message in the session. The apparatus 1000 further comprises a set of information obtaining module 1020, configured to obtain a stored set of information of a message dimension associated with the history message based on a message identifier of the history message. The apparatus 1000 further comprises a topic identifier determining module 1030, configured to determine a topic identifier indicated in the set of information of the message dimension as a target topic identifier of a topic to which the interaction message belongs. The apparatus 1000 further comprises a context information obtaining module 1040, configured to obtain stored context information of the topic based on the target topic identifier. The apparatus 1000 further comprises a reply message obtaining module 1050, configured to obtain a reply message of the digital assistant to the interaction message based on the context information.

In some embodiments, the apparatus 1000 further comprises a updating module, configured to: obtain a set of information of a session dimension associated with the session based on a session identifier of the session; and update an identifier of a current topic in the set of information of the session dimension to the target topic identifier.

FIG. 11 shows a block diagram of an electronic device 1100 in which one or more embodiments of the present disclosure may be implemented. It should be understood that the electronic device 1100 illustrated in FIG. 11 is merely exemplary and should not constitute any limitation on the functionality and scope of the embodiments described herein. The electronic device 1100 shown in FIG. 11 may be configured to implement the terminal device 110 or the server 130 in FIG. 1.

As shown in FIG. 11, the electronic device 1100 is in the form of a general-purpose electronic device. Components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor system, multiple processing units execute computer-executable instructions in parallel to improve parallel processing capabilities of electronic device 1100.

Electronic device 1100 typically includes a plurality of computer storage media. Such media may be any available media accessible to the electronic device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data and may be accessed within electronic device 1100.

The electronic device 1100 may further include additional removable/non-removable, volatile/non-volatile storage media. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 1120 may include a computer program product 1125 having one or more program modules configured to perform various methods or actions of various embodiments of the present disclosure.

The communication unit 1140 is configured to communicate with another electronic device through a communication medium. Additionally, the functionality of components of the electronic device 1100 may be implemented in a single computing cluster or multiple computing machines capable of communicating over a communication connection. Thus, the electronic device 1100 may operate in a networked environment using logical connections with one or more other servers, network personal computers (PCs), or another network node.

The input device 1150 may be one or more input devices, such as a mouse, a keyboard, a trackball, or the like. The output device 1160 may be one or more output devices, such as a display, a speaker, a printer, or the like. The electronic device 1100 may also communicate with one or more external devices (not shown) through the communication unit 1140 as needed, external devices such as storage devices, display devices, etc., communicate with one or more devices that enable a user to interact with the electronic device 1100, or communicate with any device (e.g., a network card, a modem, etc.) that enables the electronic device 1100 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for processing information, comprising:
receiving a first interaction message in a first sub-session between a user and a digital assistant, the first interaction message being from the user;
determining a first set of information associated with a primary session between the user and the digital assistant based on a primary session identifier of the primary session;
determining a sub-session identifier of the first sub-session based on the first set of information;
determining, based on the sub-session identifier, a first topic identifier of a first topic to which the first interaction message belongs;
obtaining stored context information of the first topic based on the first topic identifier; and
obtaining a first reply message of the digital assistant to the first interaction message based on the context information.

2. The method of claim 1, wherein determining the first topic identifier of the first topic to which the first interaction message belongs comprises:
searching, based on the sub-session identifier, a second set of information associated with the first session; and
determining, in response to the search of the second set of information, an identifier of a current topic indicated in the second set of information as the first topic identifier.

3. The method of claim 2, further comprising:
generating the first topic identifier and the second set of information in response to the failure of search of the second set of information; and
storing the second set of information comprising the first topic identifier, wherein the first topic identifier being stored as an identifier of a current topic of the first sub-session.

4. The method of claim 1, further comprising:
storing the first interaction information and the first reply message as part of the context information.

5. The method of claim 1, further comprising:
in response to the obtaining of the first reply message, determining a third set of information associated with the first topic based on the first topic identifier; and
determining a destination of the first reply message based on the third set of information.

6. The method of claim 1, further comprising:
generating a fourth set of information associated with the first interaction message, the fourth set of information comprising at least a message identifier of the first interaction message, the sub-session identifier, and the first topic identifier; and
generating a fifth set of information associated with the first reply message, the fifth set of information comprising at least a message identifier of the first reply message, the sub-session identifier, and the first topic identifier.

7. The method of claim 6, further comprising:
receiving a second interaction message from the user after a second topic different from the first topic is started;
in response to the second interaction message referring to at least one message of the first interaction message or the first reply message, searching a set of information associated with the at least one interaction message based on a message identifier of the at least one message;
in response to determining the first topic identifier from the searched set of information, obtaining the stored context information associated with the first topic identifier based on the first topic identifier; and
generating a second reply message for the second interaction message based on the obtained context information.

8. The method of claim 1, further comprising:
obtaining a valid identifier of a window of the first sub-session in response to a trigger operation on the first sub-session via an application; and
initializing the first sub-session based on the valid identifier of the window.

9. The method of claim 8, wherein obtaining the valid identifier of the window of the first sub-session comprises:
determining whether a window identifier provided by the application is valid;
in response to the window identifier being valid, determining the window identifier as the valid identifier of the window; and
in response to the window identifier being invalid, generating a new window identifier as the valid identifier of the window.

10. A method for processing information, comprising:
receiving an interaction message in a session between a user and a digital assistant, the interaction message being from the user and referencing a history message in the session;
obtaining a stored set of information of a message dimension associated with the history message based on a message identifier of the history message;
determining a topic identifier indicated in the set of information of the message dimension as a target topic identifier of a topic to which the interaction message belongs;
obtaining stored context information of the topic based on the target topic identifier; and
obtaining a reply message of the digital assistant to the interaction message based on the context information.

11. The method of claim 10, further comprising:
obtaining a set of information of a session dimension associated with the session based on a session identifier of the session; and
updating an identifier of a current topic in the set of information of the session dimension to the target topic identifier.

12. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
receiving a first interaction message in a first sub-session between a user and a digital assistant, the first interaction message being from the user;
determining a first set of information associated with a primary session between the user and the digital assistant based on a primary session identifier of the primary session;
determining a sub-session identifier of the first sub-session based on the first set of information;
determining, based on the sub-session identifier, a first topic identifier of a first topic to which the first interaction message belongs;
obtaining stored context information of the first topic based on the first topic identifier; and
obtaining a first reply message of the digital assistant to the first interaction message based on the context information.

13. The electronic device of claim 12, wherein determining the first topic identifier of the first topic to which the first interaction message belongs comprises:
searching, based on the sub-session identifier, a second set of information associated with the first session; and
determining, in response to the search of the second set of information, an identifier of a current topic indicated in the second set of information as the first topic identifier.

14. The electronic device of claim 13, the acts further comprising:
generating the first topic identifier and the second set of information in response to the failure of search of the second set of information; and
storing the second set of information comprising the first topic identifier, wherein the first topic identifier being stored as an identifier of a current topic of the first sub-session.

15. The electronic device of claim 12, the acts further comprising:
storing the first interaction information and the first reply message as part of the context information.

16. The electronic device of claim 12, the acts further comprising:
in response to the obtaining of the first reply message, determining a third set of information associated with the first topic based on the first topic identifier; and
determining a destination of the first reply message based on the third set of information.

17. The electronic device of claim 12, the acts further comprising:
generating a fourth set of information associated with the first interaction message, the fourth set of information comprising at least a message identifier of the first interaction message, the sub-session identifier, and the first topic identifier; and
generating a fifth set of information associated with the first reply message, the fifth set of information comprising at least a message identifier of the first reply message, the sub-session identifier, and the first topic identifier.

18. The electronic device of claim 17, the acts further comprising:
receiving a second interaction message from the user after a second topic different from the first topic is started;
in response to the second interaction message referring to at least one message of the first interaction message or the first reply message, searching a set of information associated with the at least one interaction message based on a message identifier of the at least one message;
in response to determining the first topic identifier from the searched set of information, obtaining the stored context information associated with the first topic identifier based on the first topic identifier; and
generating a second reply message for the second interaction message based on the obtained context information.

19. The electronic device of claim 12, the acts further comprising:
obtaining a valid identifier of a window of the first sub-session in response to a trigger operation on the first sub-session via an application; and
initializing the first sub-session based on the valid identifier of the window.

20. The electronic device of claim 19, wherein obtaining the valid identifier of the window of the first sub-session comprises:
determining whether a window identifier provided by the application is valid;
in response to the window identifier being valid, determining the window identifier as the valid identifier of the window; and
in response to the window identifier being invalid, generating a new window identifier as the valid identifier of the window.
